(19) United States
(12) Patent Application Publication
(10) Pub. No.: US 2024/0270231 A1
(43) Pub. Date: Aug. 15, 2024

(54) Obtaining User Input

(71) Applicant: APPLE INC., Cupertino, CA (US)

(72) Inventor: Christoph Siedentop, Los Altos, CA (US)

(21) Appl. No.: 18/421,337

(22) Filed: Jan. 24, 2024

Related U.S. Application Data
(60) Provisional application No. 63/484,243, filed on Feb. 10, 2023.

(51) Int. Cl. B60W 10/22; B60W 40/06; B60W 50/14; B60W 60/00

(52) U.S. Cl. CPC B60W 10/22; B60W 40/06; B60W 50/14; B60W 60/005; B60W 2510/22; B60W 2555/20

(57) ABSTRACT

A method includes determining a path of travel of a motorized electronic device to move from a first location to a second location. The method includes determining, by a control system, a baseline height of a body of the motorized electronic device relative to a surface of the path of travel and determining, by the control system, to notify a potential operator of the motorized electronic device. In response to determining to notify the potential operator, the method includes controlling operation of a system of the motorized electronic device using the control system to cause a change in a height of a portion of the body of the motorized electronic device relative to the baseline height of the body of the motorized electronic device.

### CROSS-REFERENCE TO RELATED APPLICATIONS

This application claims the benefit of U.S. Provisional Application No. 63/484,243, filed on Feb. 10, 2023, the contents of which are hereby incorporated by reference in their entirety for all purposes.

### FIELD

The present disclosure relates generally to the field of notifying a user and/or obtaining input of a user of a motorized electronic device.

### BACKGROUND

A motorized electronic device may be able to operate in an autonomous manner (e.g., with limited input from a user) in a variety of situations. In some instances, the motorized electronic device may determine that it may not be able to operate in a fully autonomous manner and may determine that input from the user may be desirable. In such instances, the motorized electronic device may notify the user to provide the input.

### SUMMARY

One aspect of the disclosure is a method that includes determining a path of travel of a motorized electronic device to move from a first location to a second location. The method includes determining, by a control system, a baseline height of a body of the motorized electronic device relative to a surface of the path of travel and determining, by the control system, to notify a potential operator of the motorized electronic device. In response to determining to notify the potential operator, the method includes controlling operation of a system of the motorized electronic device using the control system to cause a change in a height of a portion of the body of the motorized electronic device relative to the baseline height of the body of the motorized electronic device.

Another aspect of the disclosure is a non-transitory computer-readable storage device including program instructions executable by one or more processors that, when executed, cause the one or more processors to perform operations. The operations include determining a path of travel of a motorized electronic device to move from a first location to a second location and determining a baseline height of a body of the motorized electronic device relative to a surface of the path of travel. The operations further include determining to notify a potential operator of the motorized electronic device. In response to determining to notify the potential operator, the operations include operating of a system of the motorized electronic device using the control system to cause a change in a height of a portion of the body of the motorized electronic device relative to the baseline height of the body of the motorized electronic device.

Yet another aspect of the disclosure is a motorized electronic device that includes a body of the motorized electronic device and an actuator system of the motorized electronic device configured to cause motion of the body of the motorized electronic device. A control system is configured to determine a path of travel of a motorized electronic device to move from a first location to a second location and to determine a baseline height of a body of the motorized electronic device relative to a surface of the path of travel. The control system is further configured to determine to notify a potential operator of the motorized electronic device. In response to determining to notify the potential operator, the control system is configured to control operation of a system of the motorized electronic device to cause a change in a height of a portion of the body of the motorized electronic device relative to the baseline height of the body of the motorized electronic device.

### BRIEF DESCRIPTION OF THE DRAWINGS

FIG. 1 is a block diagram of a motorized electronic device.

FIG. 2A is a block diagram of the motorized electronic device of FIG. 1 oriented at a first height relative to a surface, in accordance with some embodiments.

FIG. 2B is an illustration of the motorized electronic device of FIG. 1 oriented at a second height relative to the surface, in accordance with some embodiments.

FIG. 3 is an illustration of the motorized electronic device of FIG. 1 following a path of travel, in accordance with some embodiments.

FIG. 4 is a block diagram of a control system of the motorized electronic device of FIG. 1, in accordance with some embodiments.

FIG. 5 is a block diagram of a method of controlling operation of the motorized electronic device of FIG. 1, in accordance with some embodiments.

FIG. 6 is a block diagram of a method of controlling operation of the motorized electronic device of FIG. 1, in accordance with some embodiments.

### DETAILED DESCRIPTION

The disclosure herein relates to motorized electronic devices that are configured to operate at least partially autonomously. A motorized electronic device may determine a path of travel from a first location to a second location and may operate autonomously to move from the first location to the second location.

In some implementations, a control system of the motorized electronic device is configured to determine that autonomous operation of the motorized electronic device may be unavailable for an upcoming portion of the path of travel. In such implementations, the control system may determine to notify a user of the motorized electronic device that autonomous operation may be unavailable for the upcoming portion of the path of travel. The control system may control operation of the motorized electronic device to cause a change in height of a portion of a body of the motorized electronic device to notify the user that autonomous operation may be unavailable for the upcoming portion of the path of travel. In some implementations, the control system may determine to obtain input from the user when autonomous operation may be unavailable, and may cause the change in height of the portion of the body of the motorized electronic device to notify the user and to obtain input from the user.

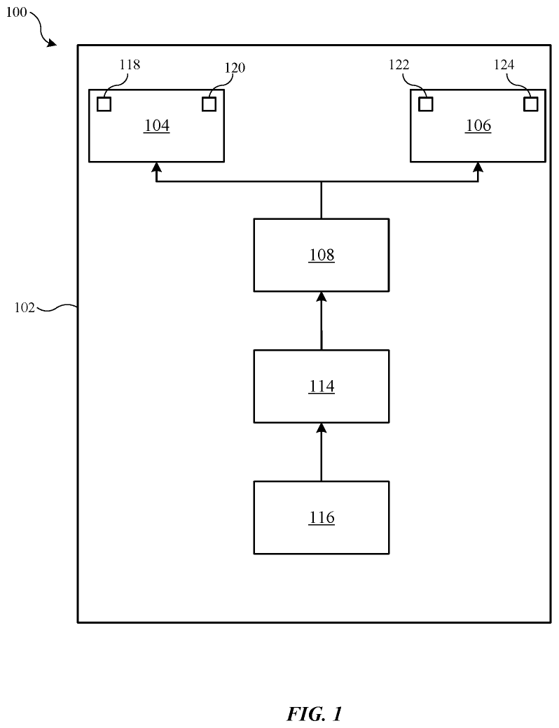

FIG. 1 is a block diagram of a motorized electronic device 100. The motorized electronic device 100 may include any type of electronic device configured to move autonomously (e.g., without intervention from a user) or partially autonomously (e.g., with some intervention from the user). For example, the motorized electronic device 100 may include a cleaning device (e.g., a vacuum, a mop, etc.), a rover device (e.g., a device configured to explore an area), or a vehicle. In some implementations the motorized electronic device 100 is configured to carry items such as cargo. In some implementations, the motorized electronic device 100 is configured to carry passengers.

The motorized electronic device 100 is shown to include a body 102. The body 102 serves as an external surface of the motorized electronic device 100 and is configured to at least partially surround various systems of the motorized electronic device 100. The body 102 may also define one or more openings through which cargo and/or passengers may enter and/or exit the motorized electronic device 100.

The motorized electronic device 100 is shown to include front wheels 104 and rear wheels 106. The front wheels 104 and the rear wheels 106 are configured to serve as an interface between the motorized electronic device 100 and a surface on which motorized electronic device 100 is traveling. In some implementations, the front wheels 104 include a front-left wheel 118 and a front-right wheel 120 and the rear wheels 106 include a rear-left wheel 122 and a rear-right wheel 124.

The motorized electronic device 100 is also shown to include a suspension system 108. In some implementations, the suspension system 108 is configured to support a sprung mass (e.g., the body 102 of the motorized electronic device 100) with respect to an unsprung mass (e.g., the front wheels 104 and the rear wheels 106). The suspension system 108 may be configured to at least partially absorb energy imparted to the front wheels 104 and the rear wheels 106 by a surface on which the motorized electronic device 100 is traveling. For example, if the motorized electronic device 100 travels over a bump on the surface on which the motorized electronic device 100 is traveling, the suspension system 108 absorbs at least a portion of the energy imparted to the front wheels 104 and the rear wheels 106 by the bump such that only a portion of the energy is transmitted to the body 102 of the motorized electronic device 100.

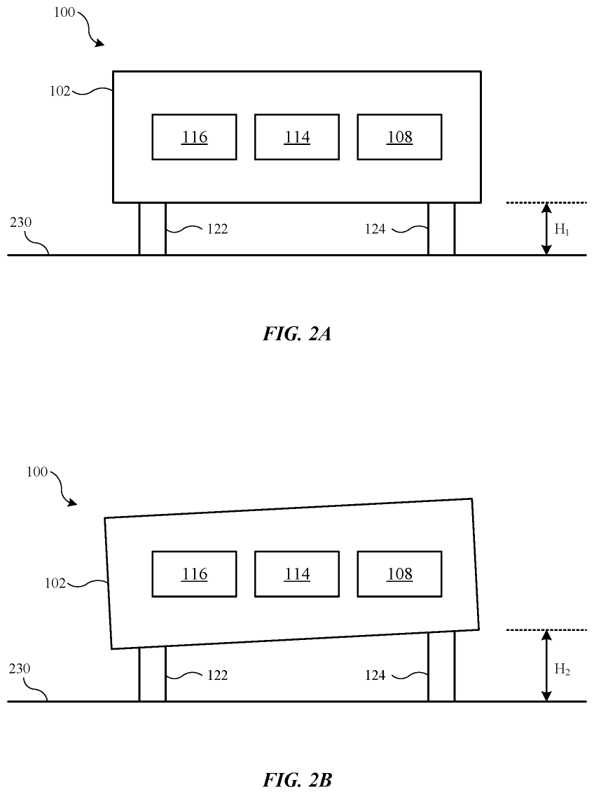

In some implementations, the suspension system 108 includes suspension components (such as an actuator system) that are configured to at least partially absorb energy and/or cause motion of the body 102 of the motorized electronic device 100. For example, the suspension system 108 may be configured to cause a change in height of a portion of the body 102 of the motorized electronic device 100. In some implementations, the suspension system 108 may include an actuator associated with each of the front-left wheel 118, the front-right wheel 120, the rear-left wheel 122, and the rear-right wheel 124 such that the suspension system 108 may be configured to operate each actuator independently to cause a change in height of the body 102 of the motorized electronic device 100 relative to a baseline height of the body 102 of the motorized electronic device 100. For example, the suspension system 108 may operate actuators associated with the front-right wheel 120 and the rear-right wheel 124 to change a height of a right portion of the body 102 of the motorized electronic device 100 relative to the baseline height of the body 102 of the motorized electronic device 100. Such implementations are described with reference to FIGS. 2A-B.

The motorized electronic device 100 further includes a control system 114 and a sensor system 116. The sensor system 116 is configured to generate one or more signals indicative of an environment external to the motorized electronic device 100. For example, the sensor system 116 may include one or more sensors such as a visible light camera, an infrared camera, a light detection and ranging sensor (LIDAR), a proximity sensor, and any other type of sensor that may generate a signal indicative of the environment external to the motorized electronic device 100. The sensor system 116 may also include a global positioning system (GPS) to provide detailed maps and directions.

The control system 114 is configured to receive one or more signals from the sensor system 116 and control an actuator system (e.g., the suspension system 108) of the motorized electronic device 100 to cause a desired motion of the motorized electronic device 100. The control system 114 is further described with reference to FIGS. 2-4.

FIG. 2A is a block diagram of the motorized electronic device 100 of FIG. 1 oriented at a first height relative to a surface 230, in accordance with some embodiments. FIG. 2B is an illustration of the motorized electronic device 100 of FIG. 1 oriented at a second height relative to the surface 230, in accordance with some embodiments. The surface 230 may be any surface on which the motorized electronic device 100 is traveling. For example, the surface 230 may be a road. As shown in FIG. 2A, the body 102 of the motorized electronic device 100 is positioned at a baseline height, H₁, relative to the surface 230. In some implementations, the baseline height may be determined by the control system 114 relative to the surface 230. For example, the control system 114 may determine the baseline height to be a first height if the surface 230 is a city road or a freeway road, and the control system 114 may determine the baseline height to be a second height if the surface 230 is a dirt road or gravel road.

In some implementations, the control system 114 may cause the suspension system 108 to change a height of a portion of the body 102 of the motorized electronic device 100 relative to the baseline height. As shown in FIGS. 2A-2B, the suspension system 108 may cause a height of a right portion of the body 102 of the motorized electronic device 100 (corresponding to the portion of the body 102 of the motorized electronic device 100 supported by the front-right wheel 120 and the rear-right wheel 124) to increase to a height of H₂ relative to the baseline height H₁. In some implementations, the suspension system 108 may cause a smaller or larger portion of the body 102 of the motorized electronic device 100 to increase in height. For example, the suspension system 108 may operate an actuator associated with the rear-right wheel 124 to increase a rear-right quadrant of the body 102 of the motorized electronic device 100 to increase to the height of H₂. As another example, the suspension system 108 may operate actuators associated with the front-right wheel 120, the rear-right wheel 124, and the rear-left wheel 122 to increase a front-right quadrant, a rear-right quadrant, and a rear-left quadrant of the body 102 of the motorized electronic device 100 to the height of H₂. More specifically, in combination the actuators displace respective portions of the body 102 upward by a distance (e.g., a distance of H₂-H₁) at the same time such that a portion of the body 102 is raised by the actuators to a height of H₂.

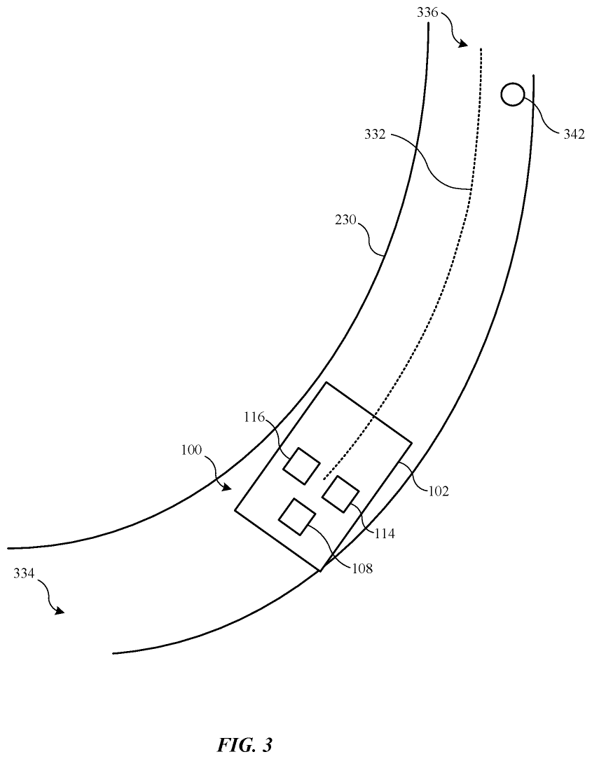

FIG. 3 is an illustration of the motorized electronic device 100 of FIG. 1 following a path of travel 332, in accordance with some embodiments. In some implementations, the control system 114 is configured to determine the path of travel 332 of the motorized electronic device 100 to move from a first location 334 to a second location 336 as the motorized electronic device 100 travels on the surface 230. In some implementations, the control system 114 may determine the path of travel 332 based on an output from a navigation system in communication with the control system 114. In some implementations, the control system 114 is an autonomous route and motion planning system that is configured to determine the path of travel 332 based on output from one or more sensors of the sensor system 116.

As the control system 114 controls operation of the motorized electronic device 100 along the path of travel 332, the sensor system 116 generates signals indicative of the environment external to the motorized electronic device 100. The control system 114 receives the signals from the sensor system 116 and, based on the signals, may determine to notify a user of the motorized electronic device 100 and/or obtain input from the user of the motorized electronic device 100. For example, the sensor system 116 may be configured to generate a signal indicative of an unexpected feature of the environment external to the motorized electronic device 100. More specifically, the sensor system 116 may generate a signal that indicates a mismatch between the path of travel 332 and a path of the surface 230 (e.g., a road may be under construction and the lanes may be in a location or configuration that does not match the path of travel 332). As another example, the sensor system 116 may generate a signal that indicates a poor weather condition (e.g., snow, ice, fog, etc.) that may make it difficult for the control system 114 to control operation of the motorized electronic device 100 along the path of travel 332. The sensor system 116 may also generate a signal that indicates an upcoming road condition 342 (e.g., a pothole, a crack, an icy patch, etc.). The implementations described above are not exhaustive but provide some examples of when the control system 114 is configured to notify the user and/or obtain the input from the user. The input may be a motion input to change the path of travel 332 of the motorized electronic device 100 to avoid and/or navigate through the unexpected feature or hazard.

In some implementations, the control system 114 may determine to notify the user and/or obtain input from the user based on an internal requirement of the motorized electronic device 100. For example, the control system 114 may determine that one or more sensors within the motorized electronic device 100 are not operating efficiently, such as due to dirt accumulation on the sensor. In some implementations, the user is any potential operator of the motorized electronic device 100. In some implementations, the user is an occupant of the motorized electronic device 100 and may operate the motorized electronic device 100 from within the motorized electronic device 100. The user may also not be an occupant of the motorized electronic device 100, but may still provide input to the motorized electronic device 100 to operate the motorized electronic device 100.

The control system 114 may be configured to determine that different levels of autonomous control may be used on different portions of the path of travel 332. For example, based on the signals received from the sensor system 116, the control system 114 may determine that a first level of autonomous control of the motorized electronic device 100 may be used for a current portion of the path of travel 332 (e.g., at the first location 334) and a second level of autonomous control may be used for an upcoming portion of the path of travel 332 (e.g., at the second location 336). These levels may be based on those specified by the Society of Automotive Engineers (“SAE”) in the J3016 recommended practice. More specifically, the control system 114 may determine that the control system 114 can operate the motorized electronic device 100 with full automation, high driving automation, or conditional automation (e.g. the first level of autonomous control) on the current portion of the path of travel 332 because the signals from the sensor system 116 do not indicate that the user should be notified or user input should be obtained, and all internal systems are operating normally. The control system 114 may also determine that the signals from the sensor system 116 indicate that the upcoming portion of the path of travel 332 includes an unexpected feature such as the upcoming road condition 342. The control system 114 may operate the motorized electronic device 100 with partial automation (e.g., the second level of autonomous control) and determine to notify the user and/or obtain input from the user to maneuver the motorized electronic device 100 around the unexpected feature when the motorized electronic device 100 is on the upcoming portion of the path of travel 332. Accordingly, the second level of autonomous control is configured to accept the input from the user to control motion of the motorized electronic device 100 when the motorized electronic device 100 is on the upcoming portion of the path of travel 332. The second level of autonomous control may include varying levels of control provided to the user. For example, the second level of autonomous control may include instances in which the user has control over the motorized electronic device 100 and some autonomous features are implemented. The second level of autonomous control may also include instances in which the user has complete control over the motorized electronic device 100 and no autonomous features are implemented.

As an example implementation, the control system 114 may determine, in advance of receiving a signal from the sensor system 116, that the first level of autonomous control is available at the first location 334 and is not available at the second location 336. The control system 114 may make the determination based on, for example, a location database or map information that includes characteristics of the first location 334 and the second location 336. The characteristics of the first location 334 and the second location 336 may include information such as surface curvature, bumpiness, height, etc. Additionally, the control system 114 may make the determination based on, for example, whether the location database or map information includes characteristics of the first location 334 and the second location 336. If the location database or map information does not include characteristics of either the first location 334 or the second location 336, the control system 114 may determine that the second level of autonomous control is required for those locations.

As described, the control system 114 may be configured to operate the motorized electronic device 100 autonomously. When the control system 114 is operating the motorized electronic device 100 autonomously, the user may not be aware that the first level of autonomous control is not available at the second location 336 based on, for example, the situations described above. In some implementations, the control system 114 is configured to control operation of a system of the motorized electronic device 100 (e.g., the suspension system 108) to cause a change in height of a portion of the body 102 of the motorized electronic device 100 relative to the baseline height to notify the user of a change of autonomous control. In some implementations, the control system 114 may determine to notify the user to provide input based on the change of autonomous control. For example, and as shown in FIGS. 2A-B, the control system 114 may control operation of the suspension system 108 of the motorized electronic device 100 to cause a change in height of a portion of the body 102 of the motorized electronic device 100 relative to the baseline height of the body 102 of the motorized electronic device 100 while maintaining the motorized electronic device 100 on the path of travel 332. The control system 114 may control operation of various actuators associated with the suspension system 108 to cause the change in height. The user may experience the change in height from H₁ to H₂ and be notified (e.g., the user may notice a difference between the baseline height H₁ and the height H₂).

In some implementations, the control system 114 may control operation of a system of the motorized electronic device 100 to cause a rate of change of the height of the portion of the body 102 relative to the baseline height of the body 102, and the rate of change has a magnitude that is greater than a threshold magnitude. For example, the control system 114 may be configured to operate the suspension system 108 to cause a rate of change in the height of the body 102 from H₁ to H₂ that is fast enough to notify the user, as a gradual change may not be sufficient to notify the user. For example, the control system 114 may be configured to operate the suspension system 108 such that the body 102 increases in height from H₁ to H₂ at a rate that is greater than a threshold rate of ten inches per second. In some implementations, the threshold rate may be between five and twenty inches per second, inclusive. In some implementations, the threshold rate may change as the height of the body 102 increases from H₁ to H₂. In such implementations, the rate of change of the threshold rate may be up to ten inches per second squared (inclusive).

In some implementations, the control system 114 may be configured to operate the suspension system 108 to maintain the body 102 at H₂ until the user is notified and/or until input from the user is obtained. The control system 114 may also be configured to operate the suspension system 108 to move the body 102 between H₁ and H₂ (e.g., oscillating the height of the body 102 between H₁ and H₂) until the user is notified and/or until input from the user is obtained.

In some implementations, the control system 114 may be configured to operate the suspension system 108 to move different portions of the body 102 between H₁ and H₂ until input from the user is obtained. For example, the control system 114 may operate the suspension system 108 to cause the front-right portion of the body 102 to increase in height to H₂ and then decrease in height to the baseline height H₁, and then subsequently operate the suspension system 108 to cause the front-left portion of the body 102 to increase in height to H₂ and then decrease in height to the baseline height H₁. The control system 114 may continue such operation of the suspension system 108 until the user is notified and/or until input from the user is obtained.

In some implementations, the control system 114 may be configured to operate the suspension system 108 to cause the front portion of the body 102 to increase in height to H₂ and then decrease in height to the baseline height H₁. The control system 114 may also be configured to operate the suspension system 108 to cause the rear portion of the body 102 to increase in height to H₂ and then decrease in height to the baseline height H₁. The control system 114 may be configured to operate the suspension system 108 to cause the front and rear portions of the body 102 to oscillate between the baseline height (H₁) and H₂ until the user is notified and/or until input from the user is obtained.

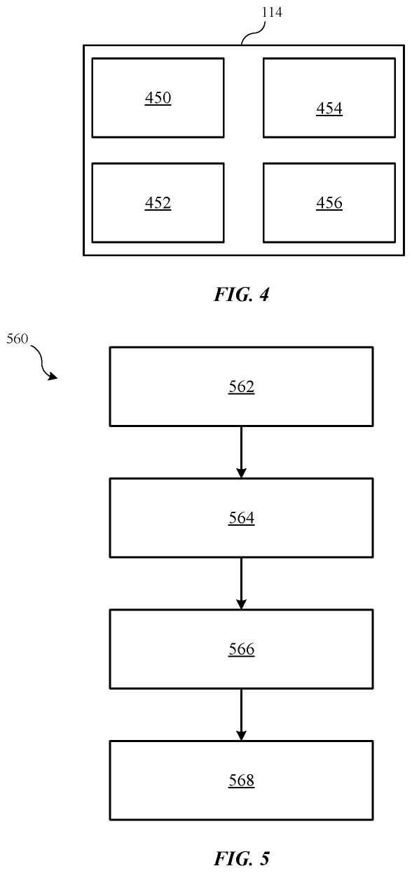

FIG. 4 is a block diagram of the control system 114 of the motorized electronic device 100 of FIG. 1. As described, the control system 114 may be configured to operate the motorized electronic device 100 as described herein. The control system 114 includes a data processing apparatus 450, a data storage device 452, a sensor interface 454, and a controller interface 456.

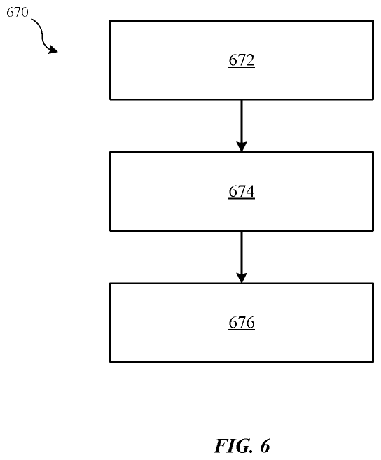

The data processing apparatus 450 is configured to execute instructions that have been stored in a data storage device 452. In some implementations, the data storage device 452 is a processor with random access memory for storing instructions read from the data storage device 452 while the instructions are being executed. The data processing apparatus 450 may include single or multiple processors each having single or multiple processing cores. Alternatively, the data processing apparatus 450 may include another type of device, or multiple devices, capable of manipulating or processing data. For example, the data storage device 452 may be a non-volatile information storage device such as a hard drive, a solid-state drive, a read-only memory device (ROM), an optical disk, a magnetic disk, or any other suitable type of storage device such as a non-transitory computer readable memory. The data storage device 452 may include another type of device, or multiple devices, capable of storing data for retrieval or processing by the data processing apparatus 450. The data storage device 452 may store instructions executable by the data processing apparatus 450 that upon execution by the data processing apparatus 450 cause the data processing apparatus 450 to perform operations, such as the operations described above and with reference to FIGS. 5-6. below.

The sensor interface 454 may be configured to receive signals and/or data from the sensor system 116 that are directed to the data processing apparatus 450 and the data storage device 452. In some implementations, the sensor interface 454 may include a wireless interface for communicating with one or more sensors of the sensor system 116 via low-power, short-range communications (e.g., using a network protocol of the motorized electronic device 100).

The controller interface 456 allows input of information to, and output of information from, other systems within the motorized electronic device 100 to facilitate control of the motorized electronic device 100. For example, the controller interface 456 may be configured to issue control signals to systems in the motorized electronic device 100 (e.g., the suspension system 108) and to receive sensor data from the sensor system 116. For example, the controller interface 456 may be a system bus, or a wired or wireless network (e.g., an area network of the motorized electronic device 100).

FIG. 5 is a block diagram of a method 560 of controlling operation of the motorized electronic device 100 of FIG. 1. The method 560 may be implemented, at least in part, by the control system 114.

At operation 562, a path of travel is determined. For example, the control system 114 may determine the path of travel 332 for the motorized electronic device 100 to travel from the first location 334 to the second location 336.

At operation 564, a signal is generated that is indicative of a feature. For example, the sensor system 116 may generate a signal that is indicative of the upcoming road condition 342 (e.g., an unexpected feature such as a road condition like a pothole, bump, ice patch, or other obstruction). In some implementations, the sensor system 116 may generate a signal indicative of poor visibility due to inclement weather conditions (e.g., snow, wind, rain, etc.). The signal generated by the sensor system 116 is received by the control system 114.

At operation 566, a determination is made to notify the user and/or obtain input from the user of the motorized electronic device 100. For example, the control system 114 may determine to notify the user and/or obtain input from the user based on the signal received in operation 564. More specifically, the control system 114 may determine, based on the signal generated by the sensor system 116, to obtain input from the user to maneuver the motorized electronic device 100 around the unexpected feature (e.g., the upcoming road condition 342). In another implementation, the control system 114 may determine, based on the signal generated by the sensor system 116, to notify the user and/or obtain the input from the user based on a weather condition. In some implementations, the control system 114 may determine to notify the user and/or obtain input from the user based on the level of autonomous driving that is available at different locations along the path of travel 332. For example, the control system 114 may determine that, based on available map data, the second level of autonomous control may be used for an upcoming portion of the path of travel 332 (e.g., after exiting a highway, turning on to an unmapped road, etc.). The control system 114 may determine to notify the user of the change in autonomous levels of control and/or obtain input from the user to navigate the upcoming portion of the path of travel 332.

At operation 568, operation of the motorized electronic device 100 is controlled by the control system 114. For example, the control system 114 may control operation of a system of the motorized electronic device 100 (e.g., the suspension system 108) to cause a change of the height of a portion the body 102 of the motorized electronic device 100 relative to the baseline height of the body 102 to notify the user of a change in autonomous control levels. In some implementations, the control system 114 may cause the change in height of the body 102 relative to the baseline height to notify the user to provide the input. As described, causing the change in the height of the portion of the body 102 relative to the baseline height of the body 102 includes causing a rate of change of the height of the body 102 relative to the baseline height, wherein the rate of change has a magnitude that is greater than a threshold magnitude. In some implementations, the control system 114 may control operation of the motorized electronic device 100 at the time for the user to provide the input. The control system 114 may also control operation of the motorized electronic device 100 in advance of when the user provides the input to allow the user time to prepare to provide the input.

FIG. 6 is a block diagram of a method 670 of controlling operation of the motorized electronic device 100 of FIG. 1. The method 670 may be implemented, at least in part, by the control system 114.

At operation 672, a path of travel is determined. For example, the control system 114 may determine the path of travel 332 for the motorized electronic device 100 to travel from the first location 334 to the second location 336.

At operation 674, a level of autonomy is determined based on the path of travel 332. For example, the control system 114 may determine, based on the path of path of travel 332, whether the motorized electronic device 100 can operate using the first level of autonomy or the second level of autonomy, as described above. More specifically, the control system 114 may determine, based on map and/or location data (e.g., provided by a GPS system, by the sensor system 116, etc.), whether the path of travel 332 corresponds to a location where the first level of autonomy is available, or if the path of travel 332 corresponds to a location in which the first level of autonomy is not available, in which case the second level of autonomy may be used. As one example, the control system 114 may determine whether autonomy features are available based on an explicit designation, included in information that is available to the control system 114, that indicates whether the first level of autonomy or the second level of autonomy are available on a particular roadway corresponding to the path of travel 332.

In some implementations, data available for the path of travel 332 may be insufficient for the control system 114 to control operation of the motorized electronic device 100 under the first level of autonomy. Insufficient data may result from a network outage, a lack of detailed mapping of the area, etc. In such implementations, the control system 114 may determine to operate the motorized electronic device 100 under the second level of autonomy.

In an example implementation, the control system 114 may determine that the motorized electronic device 100 is traveling on a major through way, and that the motorized electronic device 100 may operate under the first level of autonomy. If the control system 114 determines that the motorized electronic device 100 is traveling on a back road or parking lot, the control system 114 may determine that the motorized electronic device 100 may operate under the second level of autonomy. In some implementations, the motorized electronic device 100 may be operating under the first level of autonomy on a through way, and the path of travel 332 may indicate that the motorized electronic device 100 will be entering a parking lot. In such implementations, the control system 114 may determine to operate the motorized electronic device 100 under the first level of autonomy until a threshold distance or duration is met. For example, the control system 114 may determine that the motorized electronic device 100 may switch from the first level of autonomy to the second level of autonomy at a predetermined distance prior to the parking lot, such as at least one mile prior to reaching the parking lot. As another example, the control system 114 may determine that the motorized electronic device 100 may switch from the first level of autonomy to the second level of autonomy at least two minutes prior to the transition. The threshold distance may include other suitable distances (e.g., two miles, five miles, etc.), and the threshold duration may include other suitable durations (e.g., thirty seconds, one minute, three minutes, etc.).

At operation 676, operation of the motorized electronic device 100 is controlled by the control system 114. For example, operation of the motorized electronic device 100 may be controlled similar to operation 568 of FIG. 5. Using the above example, the control system 114 may change the height of a portion of the body 102 of the motorized electronic device 100 relative to the baseline height of the body 102 to notify the user of a change in autonomous control levels. In some implementations, the control system 114 may cause the change in height of the body 102 relative to the baseline height to notify the user to provide the input. As described, the control system 114 may cause a change in height of the portion of the body 102 when the motorized electronic device 100 is within the threshold distance or duration of moving from the first level of autonomy to the second level of autonomy. In the examples above, the input from the user may include controlling the motorized electronic device 100 to move the motorized electronic device 100 from a road into a stopping area.

As described above, one aspect of the present technology is the gathering and use of data available from various sources for use in controlling operation of the motorized electronic device 100. To the extent the information gathered to provide the above-described techniques include personal information data, such as those that uniquely identifies or can be used to contact or locate a specific person, parties that implement this technology are reminded to implement and consistently use privacy policies and practices that are generally recognized as meeting or exceeding industry or governmental requirements for maintaining personal information data private and secure. Implementers are also reminded that various techniques may be used to implement the present technology in a manner that protects user privacy. For example, local device processing may be preferred over transmission of data to online servers for processing. Further, data may be anonymized, for example a list of the attractions that a particular user is interested in may be communicated without specifically identifying the user. Users may also be permitted to opt-in and/or opt-out of certain features in accordance with their privacy preferences. In addition, it is the intent of the present disclosure that any personal information data should be managed and handled in a way to minimize risks of unintentional or unauthorized access or use.

What is claimed is:

1. A method, comprising:
determining a path of travel of a motorized electronic device to move from a first location to a second location;
determining, by a control system, a baseline height of a body of the motorized electronic device relative to a surface of the path of travel;
determining, by the control system, to notify a potential operator of the motorized electronic device; and
in response to determining to notify the potential operator, controlling operation of a system of the motorized electronic device using the control system to cause a change in a height of a portion of the body of the motorized electronic device relative to the baseline height of the body of the motorized electronic device.

2. The method of claim 1, wherein controlling operation of the system of the motorized electronic device to cause the change in height of the portion of the body relative to the baseline height includes causing a rate of change of the height of the portion of the body relative to the baseline height, the rate of change having a magnitude that is greater than a threshold magnitude.

3. The method of claim 1, wherein determining to notify the potential operator includes determining, by the control system, that a first level of autonomous control of the motorized electronic device may be used for a current portion of the path of travel and a second level of autonomous control of the motorized electronic device may be used for an upcoming portion of the path of travel, wherein the second level of autonomous control is configured to accept an input from the potential operator to control motion of the motorized electronic device when the motorized electronic device is on the upcoming portion of the path of travel.

4. The method of claim 3, wherein the input is a motion input to change the path of travel of the motorized electronic device, and the potential operator is an occupant in the motorized electronic device.

5. The method of claim 1, further comprising:
generating, by a sensor, a signal indicative of an unexpected feature of an environment external to the motorized electronic device; and
determining, by the control system, to obtain an input from the potential operator to maneuver the motorized electronic device around the unexpected feature.

6. The method of claim 5, wherein determining to obtain the input from the potential operator is based on a road condition.

7. The method of claim 1, wherein the control system is an autonomous route and motion planning system.

8. The method of claim 1, wherein the system of the motorized electronic device includes suspension components.

9. A non-transitory computer-readable storage device including program instructions executable by one or more processors that, when executed, cause the one or more processors to perform operations, the operations comprising:
determining a path of travel of a motorized electronic device to move from a first location to a second location;
determining a baseline height of a body of the motorized electronic device relative to a surface of the path of travel;
determining to notify a potential operator of the motorized electronic device; and
in response to determining to notify the potential operator, controlling operation of a system of the motorized electronic device using a control system to cause a change in a height of a portion of the body of the motorized electronic device relative to the baseline height of the body of the motorized electronic device.

10. The non-transitory computer-readable storage device of claim 9, wherein controlling operation of the system of the motorized electronic device to cause the change in height of the portion of the body relative to the baseline height includes causing a rate of change of the height of the portion of the body relative to the baseline height, the rate of change having a magnitude that is greater than a threshold magnitude.

11. The non-transitory computer-readable storage device of claim 9, wherein determining to notify the potential operator includes determining that a first level of autonomous control of the motorized electronic device may be used for a current portion of the path of travel and a second level of autonomous control of the motorized electronic device may be used for an upcoming portion of the path of travel, wherein the second level of autonomous control is configured to accept an input from the potential operator to control motion of the motorized electronic device when the motorized electronic device is on the upcoming portion of the path of travel.

12. The non-transitory computer-readable storage device of claim 9, the operations comprising:
generating a signal indicative of an unexpected feature of an environment external to the motorized electronic device; and
determining to obtain an input from the potential operator to maneuver the motorized electronic device around the unexpected feature.

13. The non-transitory computer-readable storage device of claim 12, wherein the unexpected feature is a road condition.

14. The non-transitory computer-readable storage device of claim 9, wherein determining to notify the potential operator is based on a weather condition.

15. A motorized electronic device, comprising:
a body of the motorized electronic device;
an actuator system of the motorized electronic device configured to cause motion of the body of the motorized electronic device;
a control system configured to:
determine a path of travel of the motorized electronic device to move from a first location to a second location;
determine a baseline height of the body of the motorized electronic device relative to a surface of the path of travel;
determine to notify a potential operator of the motorized electronic device; and
in response to determining to notify the potential operator, control operation of a system of the motorized electronic device to cause a change in a height of a portion of the body of the motorized electronic device relative to the baseline height of the body of the motorized electronic device.

16. The motorized electronic device of claim 15, wherein controlling operation of the system of the motorized electronic device to cause the change in height of the portion of the body relative to the baseline height includes causing a rate of change of the height of the portion of the body relative to the baseline height, the rate of change having a magnitude that is greater than a threshold magnitude.

17. The motorized electronic device of claim 15, wherein determining to notify the potential operator includes determining, by the control system, that a first level of autonomous control of the motorized electronic device may be used for a current portion of the path of travel and a second level of autonomous control of the motorized electronic device may be used for an upcoming portion of the path of travel, wherein the second level of autonomous control is configured to accept an input from the potential operator to control motion of the motorized electronic device when the motorized electronic device is on the upcoming portion of the path of travel.

18. The motorized electronic device of claim 15, further comprising a sensor configured to generate a signal indicative of an unexpected feature of an environment external to the motorized electronic device, wherein the control system is configured to obtain an input from the potential operator to maneuver the motorized electronic device around the unexpected feature.

19. The motorized electronic device of claim 18, wherein the unexpected feature is a road condition.

20. The motorized electronic device of claim 15, wherein the control system is an autonomous route and motion planning system.
